(19) United States
(12) Patent Application Publication
(10) Pub. No.: US 2026/0019710 A1
(43) Pub. Date: Jan. 15, 2026

(54) MOTION CONTROLLED CAMERA SYSTEM

(71) Applicant: DISNEY ENTERPRISES, INC., Burbank, CA (US)

(72) Inventors: Matthew Robert Walters, Toluca Lake, CA (US); Juerg Werner Grieder, Burbank, CA (US); Jacqueline Patricia Hutchinson, Temecula, CA (US)

(21) Appl. No.: 18/766,772

(22) Filed: Jul. 9, 2024

(51) Int. Cl. H04N 23/695; H04N 23/63; H04N 23/68

(52) U.S. Cl. CPC H04N 23/695; H04N 23/634; H04N 23/685

(57) ABSTRACT

A capture system includes a processing element configured to receive a target scene capture characteristic; a positioning assembly in electrical communication with the processing element; and a camera coupled to the positioning assembly. In one example, the capture system is configured to operate the camera or the positioning assembly based on the target scene capture characteristic.

### BACKGROUND

In the dynamic environment of a film set, scene capture can present many challenges, such as consistency in repeated takes, especially for scenes including varied camera and field of view positioning. Filmmakers often strive to replicate consistent framing, movement, and angle of a shot multiple times to achieve the desired performance or to account for varying shooting conditions. However, the inherent instability and variability of many camera operations, such as handheld or human supported cameras, make it difficult to exactly replicate shots, leading to discrepancies between takes. This variability can impact the continuity and visual flow of the final product, necessitating numerous retakes and adjustments, which can be both time-consuming and resource-intensive.

To address these challenges, the film industry has historically relied on mechanical aids such as tracks, dollies, or cranes. These solutions provide smoother camera movements and the ability to replicate precise camera paths across multiple takes. However, such solutions include various limitations. Tracks and cranes, for instance, require significant design and installation efforts and often are prohibitively expensive for low-budget productions. Further, conventional solutions often introduce rigidity into spontaneous or constrained shooting environments, such as tight indoor spaces or rugged outdoor locations, where the installation of such equipment is tightly defined, if even possible. These traditional solutions have not addressed the need for a cost-effective, versatile, and easily deployable system capable of ensuring shot replication with the freedom of handheld camera operation.

### BRIEF SUMMARY

In one embodiment, a capture system includes: a processing element configured to receive a target scene capture characteristic; a positioning assembly in electrical communication with the processing element; and a camera coupled to the positioning assembly, wherein the capture system is configured to operate the camera or the positioning assembly based on the target scene capture characteristic.

Optionally, in some embodiments, the positioning assembly includes: a plurality of links coupled together via a respective plurality of joints; and an actuator in electrical communication with the processing element and configured to move at least one of the plurality of links or one of the plurality of joints based on the target scene capture characteristic.

Optionally, in some embodiments, the capture system includes a locator in electrical communication with the processing element and associated with at least one of the plurality of links or one of the plurality of joints.

Optionally, in some embodiments, the processing element is configured to: determine an actual scene capture characteristic based on the locator; compare the actual scene capture characteristic to the target scene capture characteristic; determine a difference between the actual scene capture characteristic and the target scene capture characteristic based on the comparison; and adjust the positioning assembly based on the difference.

Optionally, in some embodiments, adjusting the capture system includes generating a signal, via the processing element, configured to cause the actuator to move such that the actual scene capture characteristic tracks the target scene capture characteristic.

Optionally, in some embodiments, the target scene capture characteristic includes at least one of: target spatial information for the camera or a portion of the positioning assembly; target temporal information for the camera or the portion of the positioning assembly; or target configuration information for the camera or the portion of the positioning assembly.

Optionally, in some embodiments, the processing element is further configured to provide guidance configured to prompt a user to locate the capture system based on the target scene capture characteristic.

Optionally, in some embodiments, the capture system includes a display, and the guidance includes a visual output presented on the display.

In one embodiment, a method of capturing visual media includes: receiving, via a processor, a target scene capture characteristic; operating, via the processor, at least one of:

a positioning assembly or a camera coupled to the positioning assembly based on the target scene capture characteristic; and capturing the visual media via the camera.

Optionally, in some embodiments, the positioning assembly includes: a plurality of links coupled together via a respective plurality of joints; and an actuator in electrical communication with the processor and configured to move at least one of the plurality of links or one of the plurality of joints based on the target scene capture characteristic, wherein the operating of at least one of the positioning assembly or the camera includes operating the actuator, via the processor, to move a link of the plurality of links.

Optionally, in some embodiments, the method includes: determining, via the processor, an actual scene capture characteristic based on a locator associated with at least one of the plurality of links or one of the plurality of joints; comparing, via the processor, the actual scene capture characteristic to the target scene capture characteristic; determining, via the processor, a difference between the actual scene capture characteristic and the target scene capture characteristic based on the comparison; and adjusting, via the processor, at least one of the positioning assembly or the camera based on the difference.

Optionally, in some embodiments, adjusting the at least one of the positioning assembly or the camera includes generating a signal, via the processor, the signal configured to cause the actuator to move such that the actual scene capture characteristic tracks the target scene capture characteristic.

Optionally, in some embodiments, the target scene capture characteristic includes at least one of: target spatial information for the camera or a portion of the positioning assembly; target temporal information for the camera or the portion of the positioning assembly; or target configuration information for the camera or the portion of the positioning assembly.

Optionally, in some embodiments, the method includes providing, via the processor, user guidance based on the target scene capture characteristic.

In one embodiment, a non-transitory computer-readable storage medium, the computer-readable storage medium including instructions that when executed by a processor, cause the processor to: receive a target scene capture characteristic; operate at least one of: a positioning assembly or a camera coupled to the positioning assembly based on the target scene capture characteristic; and capture visual media via the camera.

Optionally, in some embodiments, positioning assembly includes: a plurality of links coupled together via a respective plurality of joints; and an actuator in electrical communication with the processor and configured to move at least one of the plurality of links or one of the plurality of joints based on the target scene capture characteristic, wherein the operating of at least one of the positioning assembly or the camera includes operating the actuator, via the processor, to move a link of the plurality of links.

Optionally, in some embodiments, the instructions, when executed by the processor, further cause the processor to: determine an actual scene capture characteristic based on a locator associated with at least one of the plurality of links or one of the plurality of joint; compare the actual scene capture characteristic to the target scene capture characteristic;
determine a difference between the actual scene capture characteristic and the target scene capture characteristic based on the comparison; and adjust the positioning assembly based on the difference.

Optionally, in some embodiments, the instructions, when executed by the processor, further causes the processor to generate a signal configured to cause the actuator to move such that the actual scene capture characteristic tracks the target scene capture characteristic.

Optionally, in some embodiments, the target scene capture characteristic includes at least one of: target spatial information for the camera or a portion of the positioning assembly; target temporal information for the camera or the portion of the positioning assembly; or target configuration information for the camera or the portion of the positioning assembly.

Optionally, in some embodiments, the instructions, when executed by the processor, further cause the processor to provide user guidance based on the target scene capture characteristic.

### BRIEF DESCRIPTION OF THE DRAWINGS

FIG. 1 illustrates an embodiment of a capture system suitable to capture a content scene.

FIG. 2 is a perspective view of the capture system of FIG. 1.

FIG. 3 is an elevation view of the capture system of FIG. 1.

FIG. 4A is an example of a visual output of the capture system of FIG. 1.

FIG. 4B is an example of a visual output of the capture system of FIG. 1.

FIG. 5 is a schematic illustrating an example of using the capture system of FIG. 1 to capture a content scene.

FIG. 6 is a simplified block diagram of a method of generating target scene capture characteristics with the capture system of FIG. 1.

FIG. 7 is a simplified block diagram of a method of capturing a content scene with the capture system of FIG. 1.

FIG. 8 is a simplified block diagram of components of a computing system of the microclimate prediction system of FIG. 1.

### DETAILED DESCRIPTION

During production of visual content, there is often a need to capture more than one take of a particular scene, e.g., due to changes in lighting, missed lines, timing mishaps, or other factors. The capture systems disclosed enable different capture takes and shoot times to be closely if not completely aligned from a filming point of view, e.g., the camera will capture the same frame as in prior takes, without requiring the rigid, time intensive, and expensive systems as typically used to capture such content. The capture systems are configured to automatically adjust various scene capture characteristics (e.g., camera positioning) to match a desired shot and corresponding characteristics to capture a scene with fidelity and enhance the accuracy and alignment of repeated takes.

Scene capture characteristics may include one or more of spatial information, temporal information, and/or configuration information for a camera used to capture a scene. In some embodiments, the scene capture characteristics include spatial information (e.g., position and/or orientation) about where a camera should be positioned and focused for a particular point in the scene. The scene capture characteristics may also include temporal information correlated to the spatial information that further describes a time indication for a particular scene. In addition, the scene capture characteristics may include configuration information defining values of certain settings of the camera's operation (e.g., focus, zoom, shutter speed, etc.). Either or both of the spatial information or the configuration information may be defined based on the temporal information. For example, the scene capture characteristics may define the spatial information and/or configuration information as a function of the temporal information, allowing an alignment between a particular characteristic for a particular point in time with respect to the timing a scene, e.g., the camera will be at the desired height to capture a particular movement in a scene requiring that camera height.

The capture system compares the scene capture characteristic (e.g., actual spatial, temporal and/or configuration information of the capture system) and/or the camera to the desired scene capture characteristic and adjusts the same to keep the camera in a desired place, with a desired orientation, and/or configuration at a desired time.

In some embodiments, a support assembly, such as a harness, is included that enables the capture system to be worn, coupled to, or otherwise supported on a user, such as a camera operator. Further, the capture system includes a positioning assembly to reposition the camera relative to a support point and may include various linkages to enable various types of reposition (e.g., along one or more axes). Often the positioning assembly is configured to selectively activate various actuators or movement components to reposition the camera to align with the desired scene capture characteristic, providing consistent shots over different takes. In some embodiments, the capture system may provide feedback to a user to help the user stay within the adjustment range of the capture system to further aid in capturing the shot.

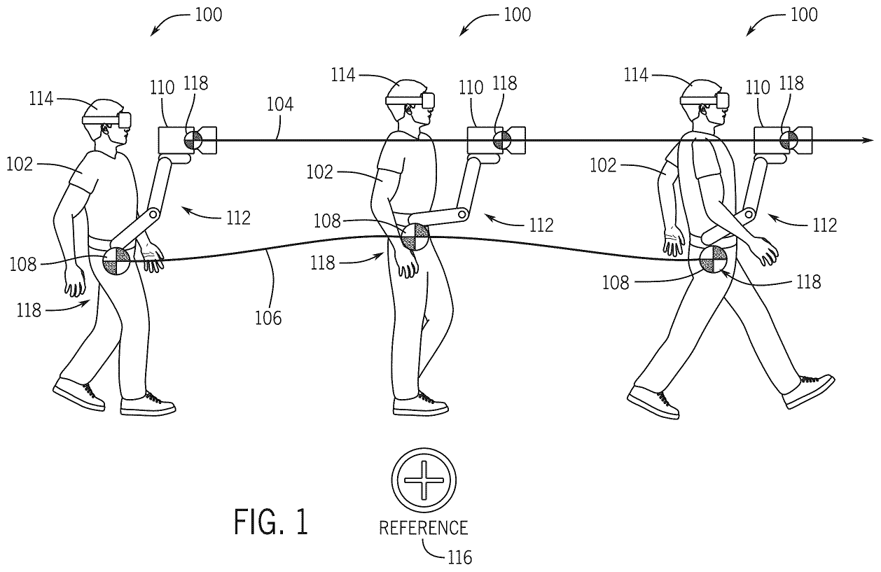

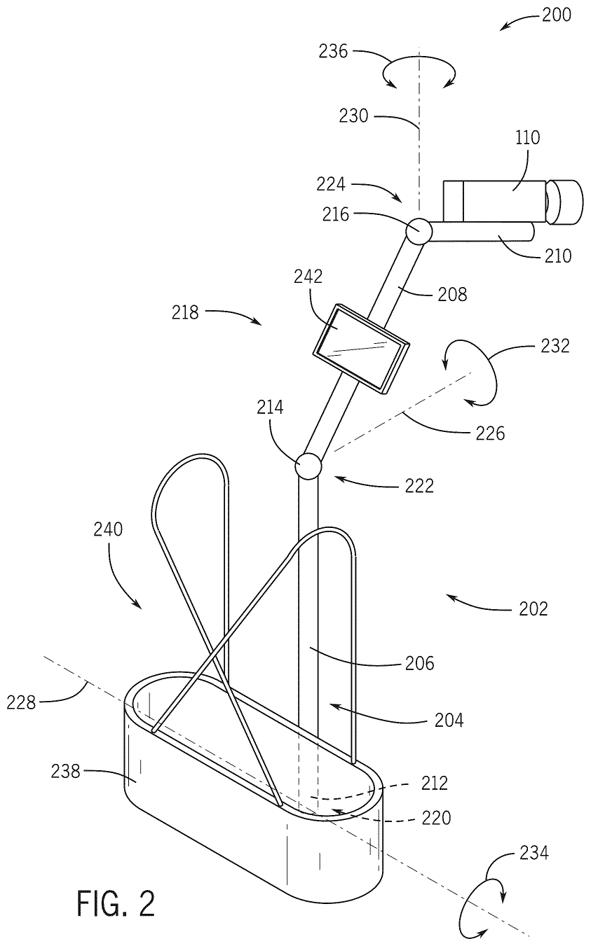

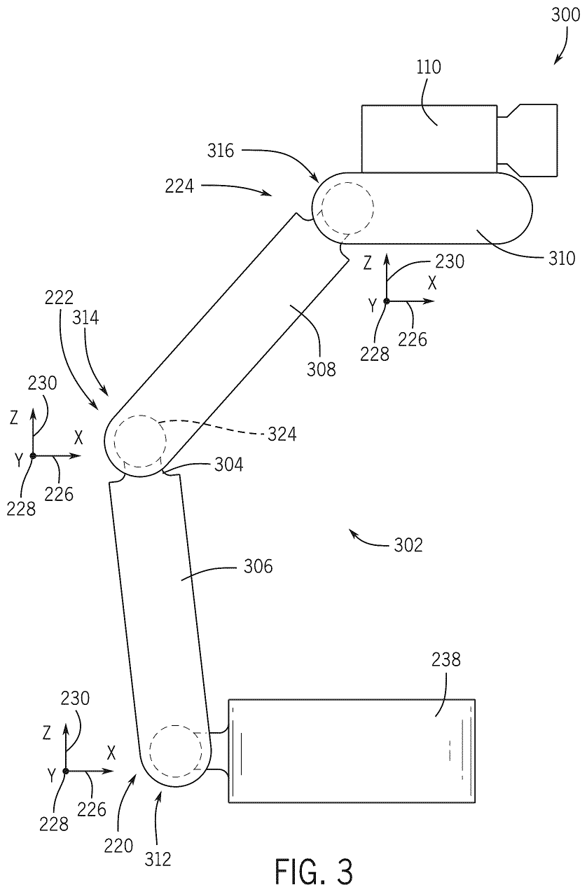

Turning to the figures, FIG. 1 shows an embodiment of a capture system 100 suitable to capture a content scene. The capture system 100 includes a positioning assembly 112. A camera 110 may be coupled to, and moveable by, the positioning assembly 112. In some embodiments, a user 102 supports (e.g., wears) the capture system 100 (such as with a support 238 or harness shown for example in FIG. 2 and FIG. 3) and moves about a scene while the capture system 100 captures the scene via the camera 110. In some embodiments, the user 102 moves (e.g., walks) through a scene along a user path 106. In embodiments where the capture system 100 is worn or otherwise supported on the user 102, a portion of the capture system 100 moves along the user path 106. Likewise, the camera 110 moves through the scene with the user 102 along a camera path 104. In many cases, neither the user path 106 nor the camera path 104 may be the desired paths to capture a scene.

To compensate for discrepancies between the actual user path 106 and/or the camera path 104 compared to desired paths, the capture system 100 adjusts the camera 110 and/or the positioning assembly 112 to track a desired path for capturing a given scene. In many embodiments, the capture system 100 receives one or more target or desired scene capture characteristics. The capture system 100 determines one or more actual or current scene capture characteristics and adjusts the positioning assembly 112 and/or the camera 110 such that the actual scene capture characteristic tracks the target scene capture characteristic.

In some embodiments, the capture system 100 includes one or more locators 118 used to determine an actual scene capture characteristic (e.g., spatial information such as location, position, or orientation) of the capture system 100 and/or camera 110. In some embodiments, the locator spatial information is determined with respect to a reference 116. The reference 116 may be stationary, moving, or a combination thereof (e.g., the reference 116 both moves and stops moving during a take of a scene). In some embodiments, a reference 116 is coupled to a portion of the positioning assembly 112. In some embodiments, a reference 116 is coupled to the camera 110.

The reference 116 and/or the locator 118 is any device suitable to determine the spatial information of the capture system 100, the user 102, or the camera 110. In some embodiments, either or both of the reference 116 and/or the locator 118 may be an optical marker, a light detection and ranging (“LIDAR”) sensor, a photogrammetry sensor, a global positioning system (“GPS”) sensor, a radio triangulation sensor, an inertial measurement unit (“IMU”), or the like. In some embodiments, the actual spatial information is determined via photographic techniques such as photogrammetry that creates a 3D model of the scene based on multiple images of the scene taken from different vantage points. In another embodiment, the spatial information is determined via a splatting technique.

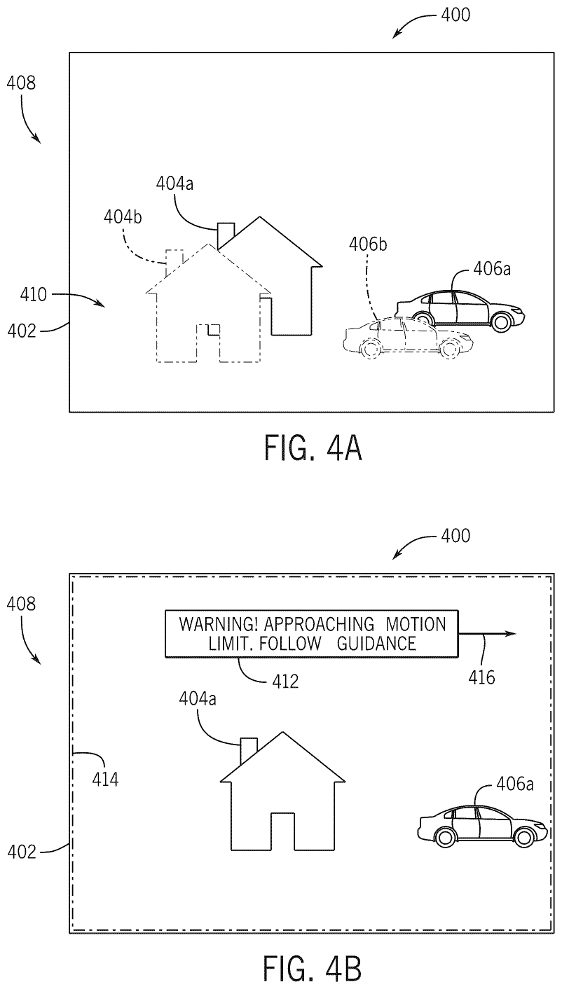

In some embodiments, the capture system 100 includes a display such as a head mounted display 114 or a panel display 242 (see, e.g., FIG. 2). As discussed in more detail with respect to FIG. 4A and FIG. 4B, the capture system 100 may generate one or more alerts, such as visual alerts, via the head mounted display 114 and/or the display 242 to guide a user to move the capture system 100 based on the target scene capture characteristic, the actual scene capture characteristic, or a difference there between.

Turning to FIG. 2, an embodiment of a capture system 200 is shown. The capture system 200 is an example of the capture system 100 discussed herein. The capture system 200 includes a processing element 204 configured to receive a target scene capture characteristic; a positioning assembly 202 in electrical communication with the processing element 204; and a camera 110 coupled to the positioning assembly 202. The capture system 200 is configured to operate the camera 110 based on the target scene capture characteristic. As used herein, operating the camera 110 includes one or more of positioning the camera 110, configuring the camera 110 (e.g., changing a value of one or more settings of the camera 110), and/or recording visual media with the camera 110. For example, the capture system 200 may receive one or more target scene capture characteristics and compare these scene capture characteristics to actual scene capture characteristics of the capture system 200 or the camera 110. The capture system 200 may adjust the positioning assembly 112 such that the actual scene capture characteristics track the target scene capture characteristics.

The capture system 200 includes a positioning assembly 202. In the embodiment shown, the positioning assembly 202 is a linkage with a link 206, a link 208, and a link 210. The links are coupled to one another by respective joints. As shown for example in FIG. 2, the link 206 is coupled to the link 208 by a joint 214. The link 208 is also coupled to the link 210 at a joint 216 at an end of the link 208 opposite the joint 214. In some embodiments, the positioning assembly 202 includes more or fewer links or joints than shown in FIG. 2.

The link 206 is coupled to a support 238 by a joint 212. The support 238 is adapted to support and/or attach the positioning assembly 202 to a user 102 or object. For example, the support 238 may be a harness, strap, belt, or the like, adapted to be worn by a user 102. The support 238 may include a shoulder harness 240, suspenders, or the like, to securely couple the capture system 200 to the user 102. In other examples, the support 238 may be a crane, boom, land-based vehicle, aerial vehicle (such as a remotely-piloted drone), dolly, track, or any other object that can move the capture system 200 within a media capture location (e.g., a set, a shooting location, or the like).

In the example shown in FIG. 2, the camera 110 is coupled to the link 210. However, the camera 110 may be coupled to any of the links 206, 208, or 210. An optional display 242 is shown coupled to the link 208. The display 242 may be coupled to any other link or joint, included as part of the camera 110, support 238, or may be omitted.

The joints of the positioning assembly 202 are each pivotable about an axis. For example, the joints of the positioning assembly 202 may be pin joints that have an axle or pin that pivotably joins the links to form an axis about which the particular joint can pivot. In some embodiments, the joints include more than one pin or axle about which the links forming the joint may pivot. For example, the link 206 is pivotable about a y axis 228 in one or more directions 234 with respect to the support 238. The link 208 is pivotable about an x axis 226 in one or more directions 232 with respect to the link 206. The link 210 is pivotable about a z axis 230 in one or more directions 236. In many embodiments, the x axis 226, y axis 228, and z axis 230 are mutually orthogonal (i.e., disposed at 90° with respect to one another) and together form a Cartesian coordinate system that enables the capture system 200 to move and/or orient the camera 110 with a wide degree of flexibility in three-dimensional space. In other embodiments, the x axis 226, the y axis 228, and/or the z axis 230 are disposed with respect to one another at angles other than 90° angles. In other embodiments, the axes may form a polar coordinate system.

Any of the links 206, 208, 210, or joints 212, 214, or 216 may be moveable by one or more actuators 218. An actuator is any device that can impart motion to another component of the capture system 200. For example, an actuator may be an electromagnetic device such as a motor, servo, power screw, solenoid, or a pneumatic/hydraulic device such as a hydraulic motor, piston, etc. As shown for example in FIG. 2, actuators 218 includes a plurality of individual actuators 220, 222, 224. In the example shown, the joint 212 is moveable by an actuator 220, the joint 214 is moveable by an actuator 222, and the joint 216 is moveable by an actuator 224. The movement of the actuators 220, 222, and 224 may be independent of one another. In some embodiments, a joint may have more than one actuator associated therewith. In some embodiments, an actuator may have a sensor or encoder that generates a signal correlated to a position of the actuator 220 within its range of motion (e.g., angle of rotation or length of extension/retraction). The sensor may also determine information such as torque, force, speed, etc. of the actuator. In some embodiments, a joint may not be actuated but may be a passive joint. The movement of the actuators 218 is coordinated and controlled by a processing element 204, such as an on-board controller included in the capture system 200.

The arrangement of links, joints, and actuators enables the capture system 200 to move the camera 110 with a high degree of flexibility and independence with respect to the support 238 or the user 102, such that the capture system 200 can compensate for the user path 106 to track the target scene capture characteristic, e.g., can match the actual scene capture characteristic to the target scene capture characteristic.

Turning to FIG. 3, an example of a capture system 300 is shown. The capture system 300 is similar to the capture system 200 and the capture system 100 in many aspects. The capture system 300 is an example of the capture system 100 discussed herein. The capture system 300 includes a processing element 204 configured to receive a target scene capture characteristic; a positioning assembly 302 in electrical communication with the processing element 204; and a camera 110 coupled to the positioning assembly 302. The capture system 300 is configured to operate the camera 110 based on the target scene capture characteristic. For example, the capture system 300 may receive one or more target scene capture characteristics and compare these scene capture characteristics to actual scene capture characteristics of the capture system 300 or the camera 110. The capture system 300 may adjust the positioning assembly 112 such that the actual scene capture characteristics track the target scene capture characteristics. Similarly, to the capture system 200, the example of the capture system 300 shown in FIG. 3 also includes three links 306, 308, 310 and three joints 312, 314, 316.

Where the capture system 300 differs from the capture system 200 is that the joints 312, 314, and 316 of the positioning assembly 302 are examples of ball-and-socket joints. As shown for example in FIG. 3, a ball-and-socket joint includes a ball received in a correspondingly-shaped socket and can articulate in one direction or simultaneously in any combination of directions 232, 234, and/or 236. The joints 312, 314, 316 may advantageously provide additional freedom of movement of the positioning assembly 302 to enable the capture system 300 to better track the target scene capture characteristic with the actual scene capture characteristic.

As with the capture system 200, any of the links 306, 308, 310, or joints 312, 314, or 316 may be moveable by one or more actuators 218 in communication with the processing element 204.

Turning to FIG. 4A and FIG. 4B, an example visual output 400 of a capture system such as the capture system 100, the capture system 200, or the capture system 300 is shown. The visual output 400 may be presented on the display 242, head mounted display 114, or another display remote from, but in communication with, the capture system. As shown for example in FIG. 4A, the visual output 400 shows an image frame 402 including a scene 408 as captured by the camera 110. The scene 408 may include one or more people or physical objects 404a, 406a, etc. that represent one or more actual scene capture characteristics as captured by the camera 110.

The image in the image frame 402 may represent one or more target scene capture characteristics. For example, the capture system may display a virtual scenes 410 with one or more virtual objects such as a virtual object 404b or a virtual object 406b that represent target scene capture characteristics. Any of the physical objects or virtual objects may be inanimate objects such as props, scenery, etc., or may be people, animals, or other organisms. The capture system may overlay or composite the view of the actual scene 408 as captured by the camera 110 with the virtual scene 410. The virtual objects 404b, 406b may represent the physical object 404a and/or physical object 406a, respectively. The virtual scene 410 may represent a desired or standard position, orientation, or configuration for the camera 110 to be in at a certain time. For example, the virtual scene 410 may be a scene created with visual effects or solid modeling software that represents a desired scene layout or vantage point. In another example, the virtual scene 410 may be a scene previously captured with a capture system or with a traditional camera system.

The capture system may automatically adjust a positioning assembly, such as the positioning assembly 112, the positioning assembly 202, or the positioning assembly 302 such that the physical object and the virtual object overlap, or substantially track one another, at a given time. For example, the positioning assembly may move one or more links or joints via an actuator such that the virtual and physical objects are in substantially the same place and same time. For example, the capture system may use a machine vision algorithm that tracks objects in the scene 408 and adjusts the positioning assembly accordingly.

The capture system may also display the virtual objects overlaid with the physical or virtual objects to alert a user 102 to move the capture system to more closely track the virtual objects with the physical objects. For example, the capture systems may have a range of adjustment within which they can move the camera 110 to track the virtual objects. If the user 102 holding or otherwise controlling the capture system is outside of the adjustment range of the capture system, the positioning assembly may not be able to compensate to achieve the desired target scene capture characteristic. Thus, a user 102 may move the capture system such that the virtual objects or people align, or are close to, the physical objects in the image frame 402, within the adjustment range of the positioning assembly.

FIG. 4B shows another example of a visual outputs 400 presented by the capture system in the head mounted display 114, the display 242, or another display. As shown for example in FIG. 4A, when an object is approaching the edge of the image frame 402 because the positioning assembly is near the envelope of its adjustment range, the capture system may display guidance such as a message 412 alerting the user 102 how and where to move. For example, a capture system may have an adjustment range of about 2 feet in a sphere or other three dimensional shape about the attachment 108 to the support 238. In other examples, the capture system may have an adjustment range of 6 inches, 1 foot, 3 feet, 4 feet, 5 feet, 6 feet or more from the attachment 108.

For example, as a physical object 406a approaches the edge of the image frame 402, the capture system may display a message 412 such as “WARNING! APPROACHING MOTION LIMIT. FOLLOW GUIDANCE.” The capture system may also optionally display a guidance indicator 416 showing the user 102 which way to move. The example guidance indicator 416 shown is an arrow, but other suitable guidance indicators 416 may be used. In some embodiments, the arrow points in a direction the user 102 should move to align the actual scene capture characteristic with a target scene capture characteristic. In some embodiments, the length, size or color of the arrow may be adjusted to indicate the amount of movement is needed from the user (e.g., a longer arrow indicates a need for more movement.)

Also shown for example in FIG. 4B, the capture system may present a visual indicator 414 such as a border around the image frame 402 to indicate an object is out of range of the positioning assembly, or is nearly out of range.

In some embodiments, a capture system may provide guidance in auditory form (e.g., through a speaker or earphones), tactile form (e.g., via a haptic actuator), or other methods suitable to alert a user 102.

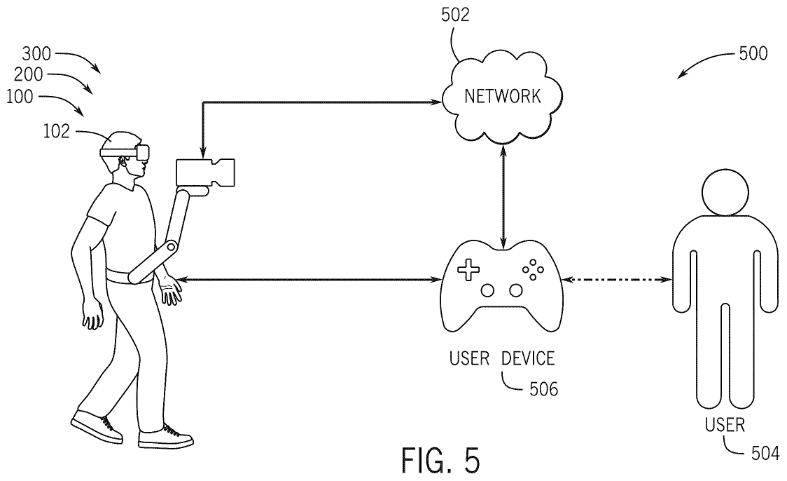

Turning to FIG. 5, an example of a system 500 is shown. The system 500 includes a capture system such as the capture system 100, the capture system 200, or the capture system 300. The 500 includes a network 502 and a user device 506. In the system 500, the capture system may operate as described, and a user 102 moves the capture system through the capture location. In the system 500, the motion of the capture system, such as the camera 110 or the positioning assembly may be partially controlled by a user 504 separate from the user 102, via the user device 506. The 506 may be a controller (such as a video game controller), a phone, table, laptop, desktop, or a specialized production console adapted to at least partially control the capture system through the network 502. An advantage of the system 500 is that one user (e.g., the user 102) can focus on moving the capture system through the capture location, and the user 504 can focus on aligning the actual scene capture characteristic to track the target scene capture characteristics.

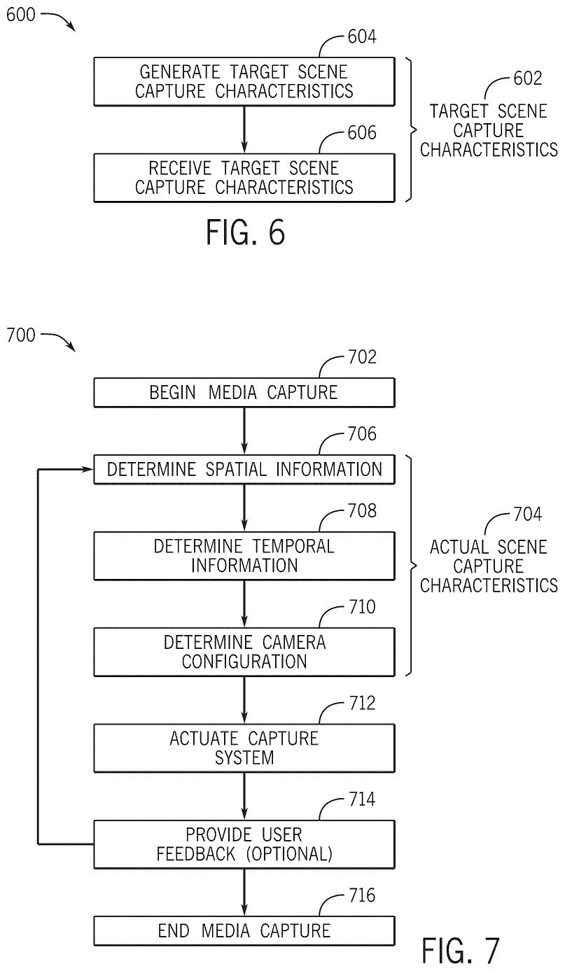

FIG. 6 illustrates an example method 600 for capturing a scene using a capture system. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method 600 includes generating one or more target scene capture characteristics at operation 604. For example, the target scene capture characteristics may include spatial information, temporal information, and/or configuration information about the camera 110. The target scene capture characteristics may represent desired scene capture characteristics. For example, and as discussed with respect to FIG. 4A and FIG. 4B, the target scene capture characteristics may be generated by a visual effects or solid modeling, or other simulation programs to represent a desired scene layout or vantage point for the camera 110. An advantage of this approach may be significant cost savings by testing various media capture layouts or setups, without the expense in time and material of performing the actual media capture.

In some examples, the target scene capture characteristics may be generated by capturing a scene initially with a capture system. In such an example, the capture system can record target scene capture characteristics such as the position, orientation, and/or configuration of the camera 110 and/or the position or orientation of the attachment 108 point on the support 238 in three dimensional space over time. For example, the capture system may capture the spatial information (e.g., location and/or orientation) of the camera 110 and/or the attachment 108 in Cartesian (e.g., X, Y, Z) space at one or more points in time (e.g., at each frame of the media being captured). Spatial information may be determined based on a relative position of the capture system to a reference 116.

The spatial information of the attachment 108, the camera 110, or another portion of the positioning assembly may be recorded at a sampling rate equal to the frame rate of the media (e.g., 24 frames per second (“FPS”), 30 FPS, 60 FPS, etc.). In other examples, the sampling rate of the spatial information may be more or less than a frame rate of the media being captured. The spatial information may be determined by comparing one or more locators 118 to a reference 116, as described. The target scene capture characteristic may be stored in the memory component 804 of the capture system.

According to some examples, the method 600 includes receiving the target scene capture characteristic at operation 606. For example, the target scene capture characteristics may be received by the processing element 204, such as by a wired or wireless connection with another processing element. In the case where the capture system records the target scene capture characteristic (e.g., as in the operation 604) the target scene capture characteristic may be retrieved from the internal memory component 804 of the capture system by the processing element 204.

FIG. 7 illustrates an example method 700 for capturing a scene using a capture system. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

According to some examples, the method 700 includes beginning media capture at operation 702. For example, a recording function of the camera 110 may be activated by a user 102, a user 504, another user, or automatically by the processing element 204. The camera 110 may begin capturing visual and/or audio information of the media (such as frames of video) in the operation 702. The media may be stored locally on the memory component 804 of the capture system or may be transmitted to another device such as through a network 502.

According to some examples, the method 700 includes determining the actual scene capture characteristics 704 at operations 706, 708, and/or 710.

According to some examples, at operation 706 of the method 700, the capture system captures actual spatial information of the capture system (including the position and/or orientation of any portion of the positioning assembly or the camera 110). The actual scene capture characteristics 704 may be determined based on a locator 118 as discussed herein, e.g., as with respect to FIG. 1 and/or operation 604 (of the method 600). In some embodiments, the capture system may determine the spatial information of a portion of the positioning assembly and calculate the spatial information of other portions of the positioning assembly. For example, if the capture system tracks the location and/or orientation of the camera 110, the spatial information of the attachment 108 may be calculated based on information related to the structure of the positioning assembly. For example, the lengths of the links may be known, and the positions of the joints may be determined based on positional encoders included with the actuators 218. Based on this information, if spatial information for one portion of the capture system is available to the processing element 204 (e.g., via the locator 118), the processing element 204 can determine the spatial information of any other portion of the capture system based on the geometry of the positioning assembly.

According to some examples, at operation 708 of the method 700, the capture system captures the actual temporal information of the capture system. For example, the capture system may start a timer operated by the processing element 204 when the operation 702 commences. In another example, the capture system may count frames of media captured in a given capture session. For example, media is typically captured as a consistent frame rate (e.g., 24 FPS, 30 FPS, 60 FPS, etc.) and the temporal information may be determined by dividing a number of captured frames by a frame rate. For example, 4980 frames/30 frames per second=166 seconds elapsed in a given media capture. In another example, the temporal information may simply include the number of frames captured.

According to some examples, at operation 710 of the method 700, the capture system determines the camera 110 configuration. For example, the capture system may include a wired or wireless data connection to the camera 110 and may receive the values of one or more settings of the camera 110. For example, the configuration may include one or more of a frame rate, an f-stop, an image sensor sensitivity, a shutter speed, a color balance, a file format, a zoom setting, or a focal point, etc. Values of these or other settings may be received by the processing element 204 of the capture system.

According to some examples, the method 700 includes actuating the capture system at operation 712. For example, the capture system may determine a difference between spatial information of the camera 110, a portion of the positioning assembly, such as the attachment 108, and the corresponding spatial information of the target scene capture characteristic. For example, the target scene capture characteristic may include information that the camera 110 should be at a location 5000 cm along the x-axis, 2000 cm along the y-axis, and 4500 cm along the z-axis from the reference 116, at 4980 frames since the start of media capture (e.g., since executing the operation 702). The capture system may determine (e.g., via the locator 118) that the actual scene capture characteristics 704 of the capture system includes information that the capture system is at a location 4500 cm along the x-axis, 2000 cm along the y-axis, and 4500 cm along the z-axis from the reference 116. In this example, the camera 110 is actually 500 cm from where it is supposed to be along the x-axis (e.g., 5000 cm-4500 cm). Based on this difference, the capture system may move one or more links of the positioning assembly to move the camera 110 to the desired position in the target scene capture characteristics 602.

In some embodiments, the capture system may determine proportional, derivative and/or integral information about spatial information. For example, the capture system may calculate an error between the actual scene capture characteristics 704 and the target scene capture characteristics 602 and may control the positioning assembly based on a the value of the error, the rate of change of the error over time (e.g., derivative), and/or accumulated error over time (e.g., integral), e.g., in a proportional-integral-derivative, proportional-derivative, or proportional-integral control loop. Based on the control loop, the capture system may move the camera 110 to the desired position in the target scene capture characteristics 602.

According to some examples, the method 700 includes providing user feedback (optional) at operation 714. For example, the capture system may display visual output 400, or generate a message 412 (visual, auditory, and/or haptic), as discussed with respect to FIG. 4A and/or FIG. 4B to prompt the user 102 to move to the desired position.

The method 700 may return to the operation 706 from the operation 712 and/or the operation 714 (if used) such that the capture system continually adjusts the actual scene capture characteristics 704 to track the target scene capture characteristics 602.

According to some examples, the method 700 includes ending media capture at operation 716. For example, the user 102 may deactivate a record function of the camera 110. In other examples, the capture may end automatically when the end of the temporal information in the target scene capture characteristics 602 has been reached, the capture system reaches a certain pre-determined spatial position or orientation, or the like.

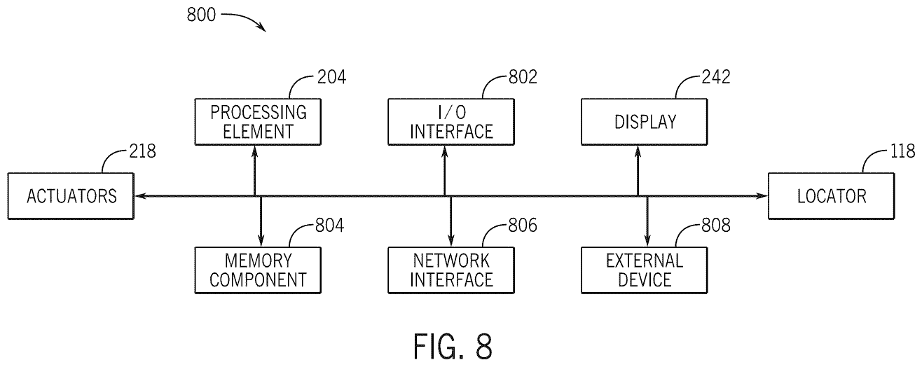

FIG. 8 is a simplified block diagram of components of a computing system 800 as may be used in any devices disclosed herein, such as any capture system, e.g., the capture system 100, the capture system 200, and/or the capture system 300, or the user device 506, the head mounted display 114, or the display 242. For example, the processing element 204 and the memory component 804 may be located at one or in several computing systems 800. This disclosure contemplates any suitable number of such computing systems computing system 800. For example, the user device 506 may be a desktop computing system, a mainframe, a blade, a mesh of computing systems 800, a laptop or notebook computing system 800, a tablet computing system 800, an embedded computing system 800, a system-on-chip, a single-board computing system 800, or a combination of two or more of these. Where appropriate, a computing system 800 may include one or more computing systems computing system 800; be unitary or distributed; span multiple locations; span multiple machines; span multiple data centers; or reside in a cloud, which may include one or more cloud components in one or more networks. A computing system 800 may include one or more processing elements 204, an input/output I/O interface 802, one or more external devices 808, one or more memory components 804, and a network interface 806. Each of the various components may be in communication with one another through one or more buses or communication networks, such as wired or wireless networks, e.g., the network 502. The components in FIG. 7 are exemplary only. In various examples, the computing system 800 may include additional components and/or functionality not shown in FIG. 7.

The processing element 204 may be any type of electronic device capable of processing, receiving, and/or transmitting instructions. For example, the processing element 204 may be a central processing unit, microprocessor, processor, or microcontroller. Additionally, it should be noted that some components of the computing system 800 may be controlled by a first processing element 204 and other components may be controlled by a second processing element 204, where the first and second processing elements may or may not be in communication with each other.

The I/O interface 802 allows a user to enter data in to computing system 800, as well as provides an input/output for the computing system 800 to communicate with other devices or services. The I/O interface 802 can include one or more input buttons, touch pads, touch screens, and so on.

The external device 808 are one or more devices that can be used to provide various inputs to the computing systems 800, e.g., mouse, microphone, keyboard, trackpad, sensing element (e.g., a thermistor, humidity sensor, light detector, etc. The external devices 808 may be local or remote and may vary as desired. In some examples, the external devices 808 may also include one or more additional sensors.

The memory components 804 are used by the computing system 800 to store instructions for the processing element 204 such as the target scene capture characteristics, the target scene capture characteristics, the operations of the method 700, captured media, user preferences, alerts, messages, etc. The memory components 804 may be, for example, magneto-optical storage, read-only memory, random access memory, erasable programmable memory, flash memory, or a combination of one or more types of memory components.

The network interface 806 provides communication to and from the computing system 800 to other devices. The network interface 806 includes one or more communication protocols, such as, but not limited to Wi-Fi, Ethernet, Bluetooth, etc. The network interface 806 may also include one or more hardwired components, such as a Universal Serial Bus (USB) cable, or the like. The configuration of the network interface 806 depends on the types of communication desired and may be modified to communicate via Wi-Fi, Bluetooth, etc.

The display 242 (and/or the head mounted display 114) provides a visual output for the computing system 800 and may be varied as needed based on the device. The display 242 may be configured to provide visual feedback to the user 102 and may include a liquid crystal display screen, light emitting diode screen, plasma screen, or the like. In some examples, the display 242 may be configured to act as an input element for the user 102 through touch feedback or the like.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, x, y, z, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A capture system comprising:
a processing element configured to receive a target scene capture characteristic;
a positioning assembly in electrical communication with the processing element; and
a camera coupled to the positioning assembly, wherein the capture system is configured to operate the camera or the positioning assembly based on the target scene capture characteristic.

2. The capture system of claim 1, wherein the positioning assembly comprises:
a plurality of links coupled together via a respective plurality of joints; and
an actuator in electrical communication with the processing element and configured to move at least one of the plurality of links or one of the plurality of joints based on the target scene capture characteristic.

3. The capture system of claim 2, further comprising:
a locator in electrical communication with the processing element and associated with at least one of the plurality of links or one of the plurality of joints.

4. The capture system of claim 3, wherein the processing element is configured to:
determine an actual scene capture characteristic based on the locator;
compare the actual scene capture characteristic to the target scene capture characteristic;
determine a difference between the actual scene capture characteristic and the target scene capture characteristic based on the comparison; and
adjust the positioning assembly based on the difference.

5. The capture system of claim 4, wherein adjusting the capture system comprises generating a signal, via the processing element, configured to cause the actuator to move such that the actual scene capture characteristic tracks the target scene capture characteristic.

6. The capture system of claim 1, wherein the target scene capture characteristic comprises at least one of:
target spatial information for the camera or a portion of the positioning assembly;
target temporal information for the camera or the portion of the positioning assembly; or
target configuration information for the camera or the portion of the positioning assembly.

7. The capture system of claim 1, wherein the processing element is further configured to provide guidance configured to prompt a user to locate the capture system based on the target scene capture characteristic.

8. The capture system of claim 7, comprising a display, wherein the guidance comprises a visual output presented on the display.

9. A method of capturing visual media comprising:
receiving, via a processor, a target scene capture characteristic;
operating, via the processor, at least one of:
a positioning assembly or a camera coupled to the positioning assembly based on the target scene capture characteristic; and
capturing the visual media via the camera.

10. The method of claim 9, wherein the positioning assembly comprises:
a plurality of links coupled together via a respective plurality of joints; and
an actuator in electrical communication with the processor and configured to move at least one of the plurality of links or one of the plurality of joints based on the target scene capture characteristic, wherein the operating of the at least one of the positioning assembly or the camera comprises operating the actuator, via the processor, to move a link of the plurality of links.

11. The method of claim 10, further comprising:
determining, via the processor, an actual scene capture characteristic based on a locator associated with at least one of the plurality of links or one of the plurality of joints;
comparing, via the processor, the actual scene capture characteristic to the target scene capture characteristic;
determining, via the processor, a difference between the actual scene capture characteristic and the target scene capture characteristic based on the comparison; and
adjusting, via the processor, at least one of the positioning assembly or the camera based on the difference.

12. The method of claim 11, wherein adjusting the at least one of the positioning assembly or the camera comprises generating a signal, via the processor, the signal configured to cause the actuator to move such that the actual scene capture characteristic tracks the target scene capture characteristic.

13. The method of claim 9, wherein the target scene capture characteristic comprises at least one of:
target spatial information for the camera or a portion of the positioning assembly;
target temporal information for the camera or the portion of the positioning assembly; or
target configuration information for the camera or the portion of the positioning assembly.

14. The method of claim 9, further comprising providing, via the processor, user guidance based on the target scene capture characteristic.

15. A non-transitory computer-readable storage medium, the computer-readable storage medium including instructions that when executed by a processor, cause the processor to:
receive a target scene capture characteristic;
operate at least one of:
a positioning assembly or a camera coupled to the positioning assembly based on the target scene capture characteristic; and
capture visual media via the camera.

16. The non-transitory computer-readable storage medium of claim 15, wherein the positioning assembly comprises:
a plurality of links coupled together via a respective plurality of joints; and
an actuator in electrical communication with the processor and configured to move at least one of the plurality of links or one of the plurality of joints based on the target scene capture characteristic, wherein the operating of the at least one of the positioning assembly or the camera comprises operating the actuator, via the processor, to move a link of the plurality of links.

17. The non-transitory computer-readable storage medium of claim 16, wherein the instructions, when executed by the processor, further cause the processor to:
determine an actual scene capture characteristic based on a locator associated with at least one of the plurality of links or one of the plurality of joint;
compare the actual scene capture characteristic to the target scene capture characteristic;
determine a difference between the actual scene capture characteristic and the target scene capture characteristic based on the comparison; and
adjust the positioning assembly based on the difference.

18. The non-transitory computer-readable storage medium of claim 17, wherein the instructions, when executed by the processor, further causes the processor to generate a signal configured to cause the actuator to move such that the actual scene capture characteristic tracks the target scene capture characteristic.

19. The non-transitory computer-readable storage medium of claim 15, wherein the target scene capture characteristic comprises at least one of:
target spatial information for the camera or a portion of the positioning assembly;
target temporal information for the camera or the portion of the positioning assembly; or
target configuration information for the camera or the portion of the positioning assembly.

20. The non-transitory computer-readable storage medium of claim 15, wherein the instructions, when executed by the processor, further causes the processor to provide user guidance based on the target scene capture characteristic.
